(19) United States
(12) Patent Application Publication
(10) Pub. No.: US 2008/0140256 A1
(43) Pub. Date: Jun. 12, 2008

(54) Robot apparatus and control method therefor

(75) Inventor: Manabu Nishiyama, Kawasaki-Shi (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/896,605

(22) Filed: Sep. 4, 2007

(30) Foreign Application Priority Data
Sep. 29, 2006 (JP) 2006-266822

(51) Int. Cl. G05B 19/00

(52) U.S. Cl. 700/255; 901/47

(57) ABSTRACT

There is provided a robot apparatus which can improve work safety while ensuring high working efficiency and a control method for the robot apparatus. The robot apparatus includes a moving body detection unit which generates a predicted moving range for a movable unit region by predicting a range within which the movable unit region moves using a plurality of images sequentially sensed by an image sensing unit and attempts to detect a moving body in the predicted moving range and a control unit which, if a moving body is detected by the moving body direction unit, changes the operation of a movable unit.

### CROSS REFERENCE TO RELATED APPLICATIONS

This application is based upon and claims the benefit of priority from the prior Japanese Patent Applications No. 2006-266822, filed on Sep. 29, 2006; the entire contents of which are incorporated herein by reference.

### BACKGROUND OF THE INVENTION

1. Field of the Invention

The present invention relates to a safety robot control apparatus mainly intended to, in a robot equipped with arms for work, prevent a collision of the robot with a nearby person using visual information.

2. Related Art

Numerous studies have conventionally been made on a method called visual feedback for, in work with arms of a robot, detecting a work object in an image and performing control using a three-dimensional position as a target position. The technique is expected to become essential for robots to perform complex work in human living space in the future.

On the other hand, the possibility of a collision with a person increases with an increase in opportunities for robots to perform work near people. Since an arm with a plurality of joints, in particular, is complex in motion, it is difficult for people to predict its motion. Accordingly, it is conceivable that a sudden motion of a robot may cause an accident.

In order to ensure safety at the time of work with arms, there have conventionally been developed a method for detecting a collision by a force sensor in an arm joint, a tactile sensor easy to be attached to an arm, and the like.

[Patent Document 1] JP-A 2006-21287 (Kokai) (Waseda University and Matsushita Electric Industrial Co., Ltd., “DEVICE FOR DETECTING CONTACT FORCE OF ROBOT”)

[Patent Document 2] JP-A 2003-71778 (Kokai) (National Institute of Advanced Industrial Science and Technology and NITTA CORPORATION, “TACTILE SENSOR FOR ROBOT ARM”)

However, conventional methods such as one for activating a safety device after contact (collision) and one for always slowly moving an arm with a possible collision in mind may both lead to a reduction in working efficiency.

### SUMMARY OF THE INVENTION

The present invention provides a robot apparatus which can improve work safety while ensuring high working efficiency and a control method for the robot apparatus.

According to an aspect of the present invention, there is provided a robot apparatus including

a movable unit;

an image sensing unit which senses an image of a surrounding environment;

an image recognition unit which detects, in the image, a movable unit region in which the movable unit appears;

a moving body detection unit which generates a predicted moving range for the movable unit region by predicting a range within which the movable unit region moves using a plurality of the images sequentially sensed and attempts to detect a moving body in the predicted moving range; and

a control unit which, if the moving body is detected, changes operation of the movable unit.

According to an aspect of the present invention, there is provided a control method for a robot apparatus having a movable unit and an immovable unit, the movable unit being formed to be movable with respect to the immovable unit, the method including

a step of sensing an image of a surrounding environment by an image sensing unit;

a step of detecting, in the image, a movable unit region in which the movable unit appears;

steps of generating a predicted moving range for the movable unit region by predicting a range within which the movable unit region moves using a plurality of the images sequentially sensed and attempting to detect a moving body in the predicted moving range; and

a step of, if the moving body is detected, changing operation of the movable unit.

### BRIEF DESCRIPTION OF THE DRAWINGS

FIG. 1 is a view of the outer appearance of a robot apparatus according to an embodiment of the present invention;

FIG. 2 is a block diagram of the robot apparatus;

FIG. 3 is a flowchart showing a robot control procedure;

FIG. 4 shows charts of examples of a pattern of optical flow information corresponding to motions of the robot;

FIG. 5 is a chart of an example of optical flow information;

FIG. 6 is a chart of the optical flow information for an arm region;

FIG. 7 is a chart for calculation of the motion vector information for a whole arm;

FIG. 8 is a chart of a binary image obtained by binarizing an image in the arm region;

FIG. 9 is a chart of the predicted moving range for the arm; and

FIG. 10 is a view of the outer appearances of an image sensing apparatus, arm and their surroundings according to another embodiment of the present invention.

### DETAILED DESCRIPTION OF THE INVENTION

An embodiment of the present invention will be explained below with reference to the drawings.

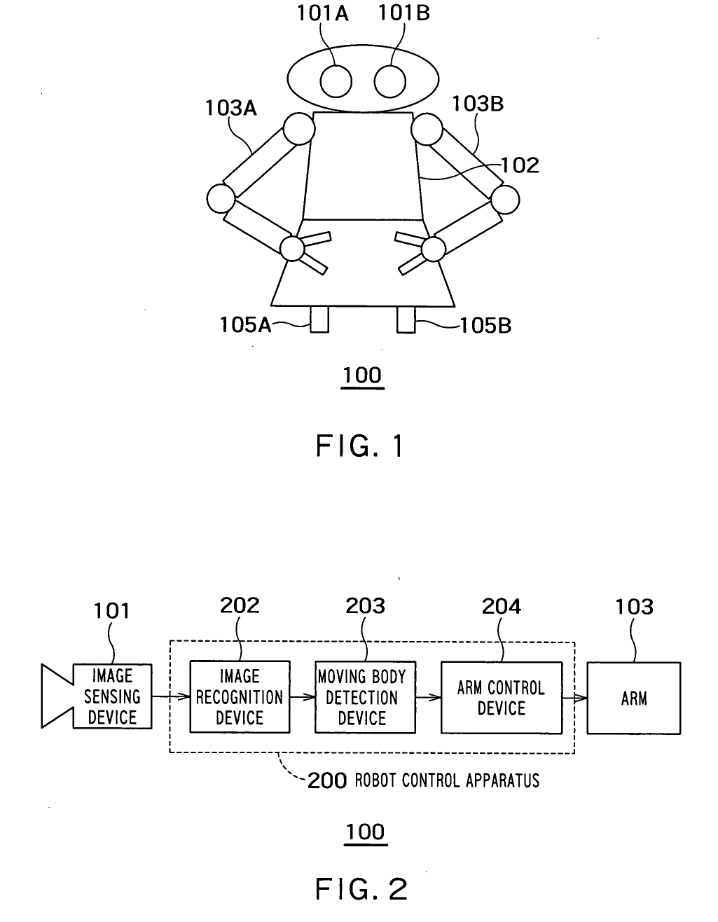

This embodiment will be explained taking, as an example, a robot 100 which has a main body unit (immovable unit) 102 equipped with arms 103A and 103B, image sensing devices 101A and 101B set in its head, and moving devices 105A and 105B, as shown in FIG. 1.

The components of a robot control apparatus according to this embodiment are all incorporated in the robot 100. FIG. 2 shows a block diagram of the robot 100 having the robot control apparatus 200.

Referring to FIG. 2, an image sensing device 101 acquires an image of the work space for an arm 103. The image sensing device 101 is a conventional CCD or CMOS camera. The image is acquired as a set of digital values including the value of luminance of each pixel and values representing a color such as an RGB color. The color mode (color/monochrome) and size of the captured image depend on the details of processing in an image recognition device 202.

The image recognition device 202 detects a region for a work object and one for the arm 103 in an image acquired by the image sensing device 101. The image recognition device 202 needs to be capable of acquiring regions for a work object and one for the arm 103 in addition to image processing for regular work. Since these pieces of information are also often necessary for regular work, the function of acquiring them can be easily added to a conventional arm control system.

A moving body detection device 203 calculates velocity vector distribution information from an image of a newly acquired frame and an image of a preceding frame and judges the presence or absence of a moving body in an arm region obtained from the image recognition device 202. An arm control device 204 controls the arm 103. For example, if the moving body detection device 203 finds a moving body (intruding object), the arm control device 204 receives notification of the finding, shifts to an emergency mode, and reduces the velocity of the arm 103. The arm 103 has several joints, and by driving of the joints the arm 103 moves.

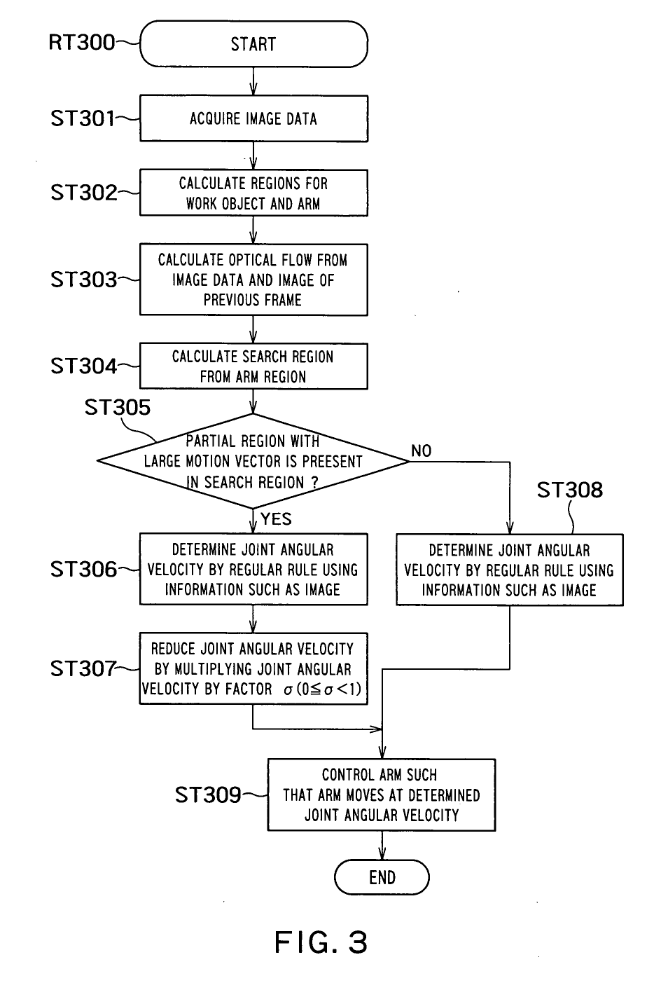

The operation of this embodiment with the above-described configuration will be explained. FIG. 3 is a flowchart showing a procedure RT300 for the robot control apparatus 200 of this embodiment. The procedure will be explained below on the basis of FIG. 3.

First, in step ST301, the image sensing device 101 acquires an image. Assume that a work object and the arm 103 of the robot 100 itself appear in the acquired image.

In step ST302, the image recognition device 202 obtains a work object region and an arm region (i.e., a movable unit region) from the acquired image data. In many cases, the robot control apparatus 200 of this embodiment is used in the form of a function added to a visual feedback arm control system. In visual feedback, the processes of obtaining the position of the work object and that of the arm 103 from the image and determining a control method from the relationship between them are often performed. Accordingly, necessary data can be acquired by utilizing the result.

Additionally, many studies have been made on visual feedback so far, and there have been proposed a large number of methods for detecting a work object and the arm 103. Since a work object region and the arm region can be obtained by the use of such a method, a detailed explanation thereof will be omitted here. The simplest example of the method is to paint the work object and the arm 103 in a predetermined color and detect the color in an image. The obtainment can be achieved by the example or the like.

In the next step, step ST303, the moving body detection device 203 calculates optical flow information (pieces of velocity vector distribution information of each pixel within the image) from the image of a target frame and the image of the immediately preceding frame. There are a plurality of available methods for obtaining optical flow information. With the use of a method described in, e.g., Lucas, Kanade, et al., “An iterative image registration technique with an application to stereo vision”, the pieces of velocity vector distribution information within the image can be obtained. A detailed method for calculating optical flow information will be omitted here.

In the case of the robot 100, in which the arm 103 and image sensing device 101 are both set above the moving device 105, as in this embodiment, a motion of the robot 100 itself causes an apparent motion in an image. To eliminate effects of the motion, processing as described below is performed, in addition to regular calculation of optical flow information.

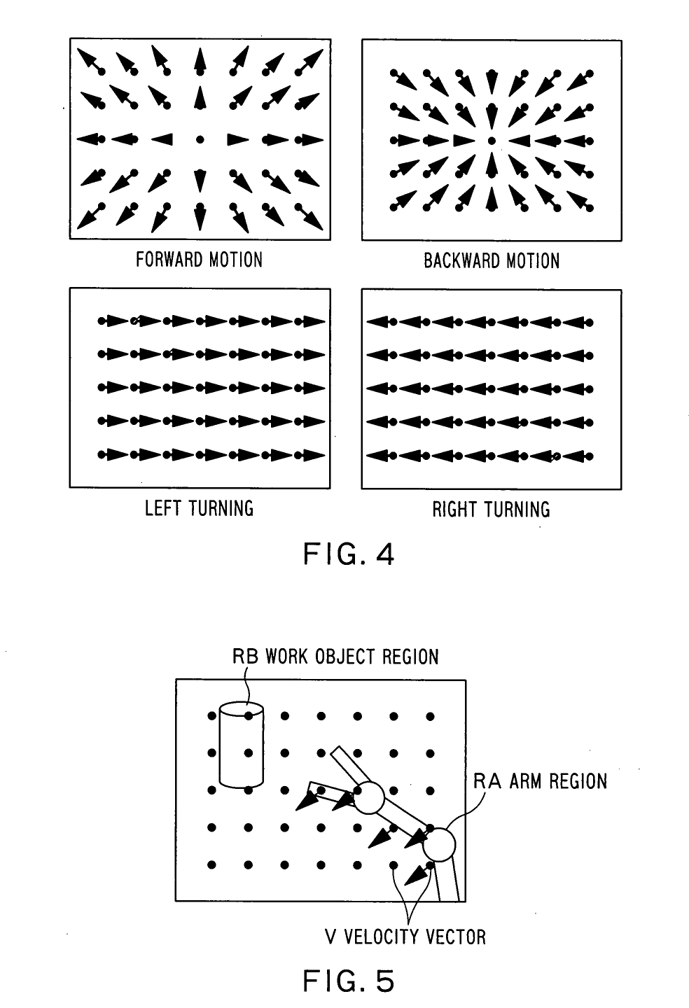

The motion information of the robot 100 itself is first acquired. The motion information can be obtained from a control device (not shown) of the moving device 105. Apparent optical flow information is predicted from the acquired motion information. The simplest method is to prepare patterns of optical flow information corresponding to motions of the robot 100, as shown in FIG. 4, and use the pieces of velocity vector distribution information having undergone multiplication by a factor corresponding to the velocity. With this method, a predicted value of optical flow information can be acquired. The predicted value of optical flow information thus obtained is subtracted from optical flow information obtained from the images, thereby eliminating the effects of the motion of the robot 100 itself.

In step ST304, the moving body detection device 203 determines a search region for which the presence or absence of a moving body (intruding object) is judged, using the arm region information obtained in step ST302. The determination is performed in the following manner. As shown in FIG. 5, e.g., pieces V of velocity vector distribution information across the whole image are obtained in step ST303.

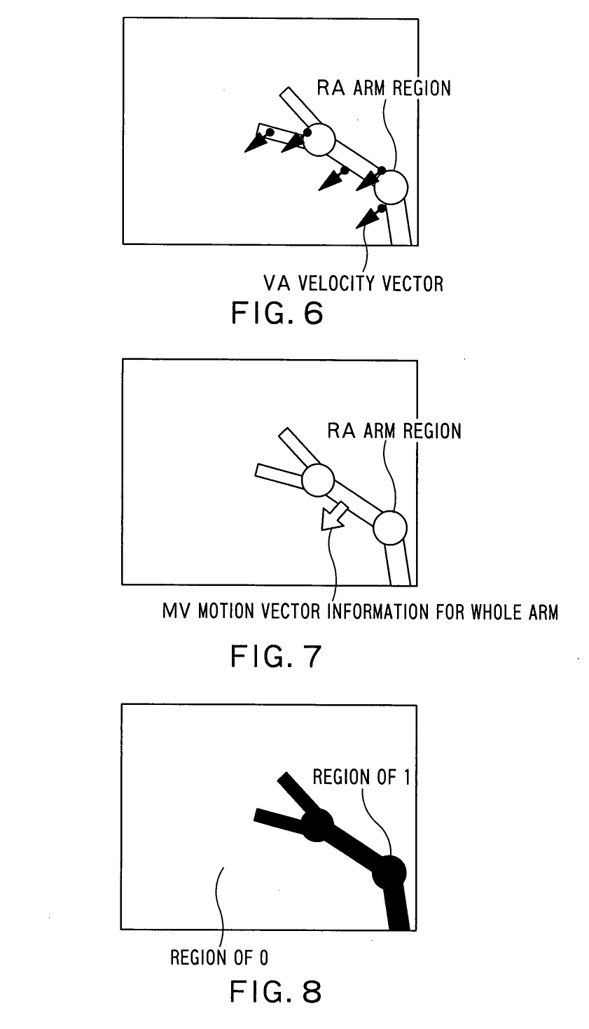

As shown in FIG. 6, only pieces VA of velocity vector distribution information in an arm region RA are extracted from the pieces V of velocity vector distribution information. As shown in FIG. 7, pieces MV of motion vector information for the whole arm 103 is generated by calculating the average value of the pieces VA of velocity vector distribution information in the arm region RA. The above-described operation shows a rough motion of the arm 103.

A predicted moving range for the arm 103 in subsequent frames is obtained using the piece MV of motion vector information for the whole arm 103. First, as in FIG. 8, a binary image with “1” in the arm region RA and “0” in the remaining region is created. The whole binary image is slightly moved in a direction of velocity (i.e., a moving direction) of the arm 103. A region of “1” (black in FIG. 8) of the obtained image is added to the original binary image.

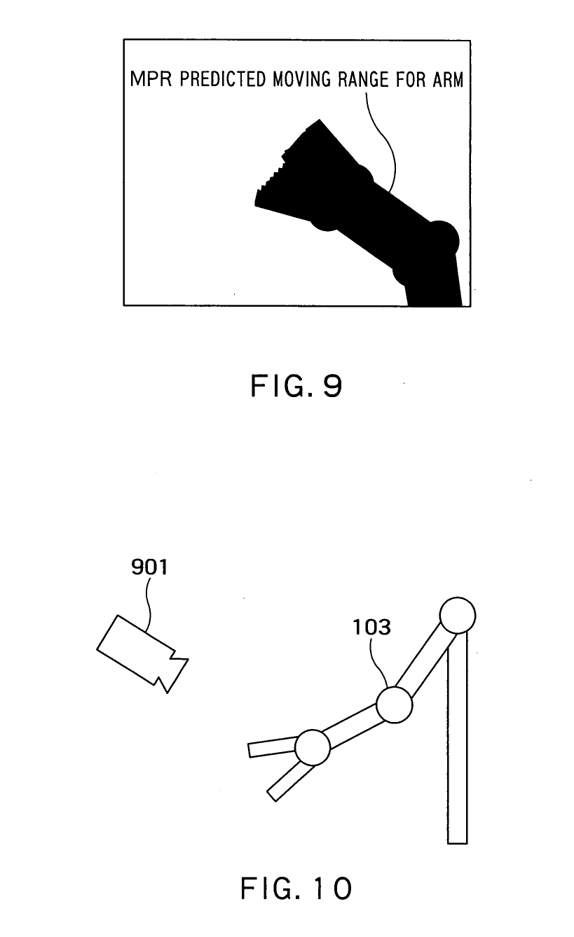

This operation is repeated a plurality of times, the number of which is proportional to the velocity of the arm 103. The higher a proportionality factor between the velocity and the number of times, the wider a range to be monitored becomes and the higher the level of safety becomes. However, even a small movement of a moving body (intruding object) toward the arm 103 reduces the velocity of the arm 103. The factor is set according to a task in consideration of the balance between safety and working efficiency. A region of “1” (black) obtained with the above-described operation has a shape similar to that obtained by expanding the region of “1” of the original image in the direction of velocity of the arm 103, as in FIG. 9. The region becomes a predicted moving range MPR for the arm 103.

The predicted moving range MPR may be expanded by a predetermined number of pixels regardless of the velocity of the arm 103, instead of being expanded in the direction of velocity of the arm 103 by pixels, the number of which is proportional to the velocity of the arm 103. Alternatively, it is permitted to generate the predicted moving range by expanding it by a desired number of pixels in the direction of velocity of the arm 103 and further expand the obtained predicted moving range in an outward direction (i.e., a direction toward the remaining range of the binary image exclusive of the predicted moving range).

A case has been described thus far where the number of joints of the arm 103 is small, and there is no harm in representing a motion of the whole arm 103 by the one piece MV of motion vector information. If the number of joints of the arm 103 is large, the one piece MV of motion vector information may be insufficient to represent a motion of the arm 103. In this case, processes of dividing the region for the arm 103 into several partial regions and calculating a piece of motion vector information for each of the divided partial regions are performed, instead of obtaining the piece MV of motion vector information for the whole arm 103. Each partial region of the region for the arm 103 is expanded in the direction of a corresponding one of all the pieces of motion vector information thus obtained, and a region obtained by combining the expanded partial regions is set as the predicted moving range for the arm 103.

With the above-described method, the predicted moving range MPR for the arm 103 is calculated. The region is set as a search region for a moving body (intruding object).

In step ST305, the moving body detection device 305 judges the presence or absence of a moving body in the search region. The judgment is performed in the following manner. Pieces of velocity vector distribution information in a work object region RB and those in the arm region RA are first eliminated from the optical flow information obtained in step ST303.

Pieces of velocity vector distribution information in the whole region of the image except for the search region obtained in step ST304 are also eliminated. Of the remaining pieces of velocity vector distribution information, pieces with velocity vector magnitudes larger than a predetermined threshold value are extracted. If the group of extracted velocity vectors is concentrated in a small region (i.e., a group of velocity vectors which has magnitudes larger than the predetermined threshold value and occupies a region larger than a predetermined size is detected), it is judged that there is a moving body (intruding object) in the search region, and the flow shifts to step ST306. Otherwise, it is judged that there is no danger of a collision, and the flow advances to step ST308.

In steps ST306 and ST308, the arm control device 204 performs regular arm control on the basis of information such as an image and the like and calculates the velocity of each arm joint. Since this process remains unchanged from before the addition of the function according to this embodiment, and a control method differs according to a task, a detailed explanation thereof will be omitted. The control methods have a commonality in that the pieces of velocity information of the joints of the arm 103 are obtained as the result of the control.

In step ST307, the arm control device 204 performs the process of coping with a case where a moving body (intruding object) which may collide with the robot 100 is detected in step ST305. A factor σ is determined in advance such that 0≦σ<1 holds. Letting Ω₁, Ω₂, . . . , Ωₙ be joint angular velocities obtained in step ST306, an actual angular velocity Ωᵢ′ is calculated by:

Ωᵢ′=σΩᵢ

### The value of the factor σ represents the extent to which the process of coping with a moving body (intruding object), if any, is performed.

For example, if σ=0, when there is a moving body (intruding object), the arm 103 is immediately stopped. As a approaches 1, a reduction in velocity becomes small. As in the determination of a search region, the factor can be determined according to a task in consideration of the balance between safety and working efficiency.

Finally, in step ST309, the arm control device 204 controls the arm 103 such that each joint of the arm 103 moves at the finally determined joint angular velocity corresponding to the joint.

This embodiment is an example in which a safety control function is added to the robot 100, which performs work with its arms. If arm control is originally performed using visual information, the safety can be relatively easily improved, and the addition of the function does not cause a large increase in computation load.

Also, the search range for a moving body (intruding object) can be dynamically determined according to a motion of the arm 103. Although there is a possibility of implementing a similar function by arranging a large number of range sensors such as an ultrasonic sensor on the surface of the arm 103, many modifications need to be made to the hardware to add the function, and thus, the implementation of the function is difficult. It is also very difficult to determine a search range according to circumstances. Since the use of an image allows software to implement most parts of the function, the cost can be reduced.

As described above, a moving body in motion is searched for in a sensed image of the work space using optical flow information well-known in the field of image processing. If a moving body is detected, a control method to be used is switched to one for the emergency mode, and a measure to ensure safety such as reducing the velocity of the arm 103 or changing the trajectory is taken. The detection of a moving body is performed only around the arm 103 so as not to react to a moving body (intruding object) in a completely unrelated place, thereby ensuring high working efficiency.

In other words, it is possible to implement the robot control apparatus 200 adaptable to any circumstances, which lets the robot 100 quickly move so as to fully utilize its capacity if there is no danger of a collision and reduces the velocity if the possibility of a collision increases.

This makes it possible to improve the safety of the robot 100 with the arms 103 by the addition of an image processing function requiring a relatively small computer resources. A search is made only around the arm 103, and even if there is a moving body (intruding object) in a place with no effect on work with the arm 103, the moving body is neglected. This saves excessively reducing the velocity of the arm 103 and prevents a large reduction in working efficiency.

FIG. 10 shows another embodiment of the present invention. This embodiment is an example in which an image sensing device 901 is set outside a robot. In this case as well, it is possible to achieve safe control capable of coping with a moving body (intruding object) using the same method as that of the first embodiment.

This embodiment has a feature in that it is possible to ensure a wider field of view than that in the case where the image sensing device 101 is set in the robot 100 itself and can monitor a wide range. This embodiment can be extended by arranging a plurality of the image sensing devices 901 so as to ensure a wider field of view. It also becomes possible to determine a search range in a depth direction and detect a moving body (intruding object) by obtaining a distance using stereo vision from the plurality of image sensing devices 901.

Note that although the above-described embodiment uses the arm 103 as a movable unit, various other types of movable units such as a leg may be used. In short, this embodiment only needs to be a robot apparatus formed such that a movable unit can move with respect to a main body unit (immovable unit) 102. A work object may not be present, and this embodiment may be applied to, e.g., a case where a gesture is made with an arm 103.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A robot apparatus comprising:
a movable unit;
an image sensing unit which senses an image of a surrounding environment;
an image recognition unit which detects, in the image, a movable unit region in which the movable unit appears;
a moving body detection unit which generates a predicted moving range for the movable unit region by predicting a range within which the movable unit region moves using a plurality of the images sequentially sensed and attempts to detect a moving body in the predicted moving range; and
a control unit which, if the moving body is detected, changes operation of the movable unit.

2. The robot apparatus according to claim 1, wherein
if the moving body is detected, the control unit reduces operating speed of the movable unit.

3. The robot apparatus according to claim 1, wherein
if the moving body is detected, the control unit changes a trajectory of the movable unit according to a motion of the movable unit such that the movable unit avoids the moving body.

4. The robot apparatus according to claim 1, wherein
the moving body detection unit generates velocity vector distribution information within a target one of the plurality of images using the plurality of images sequentially and, if a group of velocity vectors which does not include a velocity vector in the movable unit region, has magnitudes larger than a predetermined threshold value, and occupies a region larger than a predetermined size, of the velocity vector distribution information, is detected in the predicted moving range, detects the region where the group of velocity vectors is located as the moving body.

5. The robot apparatus according to claim 4, wherein
the moving body detection unit generates second velocity vector distribution information arising from operation of the robot apparatus itself and
subtracts the second velocity distribution information from the velocity vector distribution information in advance when detecting the moving body.

6. The robot apparatus according to claim 1, wherein
the moving body detection unit generates the predicted moving range by predicting a moving direction of the movable unit region using the plurality of images sequentially sensed and expanding the movable unit region in the predicted moving direction of the movable unit region by a predetermined number of pixels.

7. The robot apparatus according to claim 6, wherein
the moving body detection unit expands the predicted moving range by a predetermined number of pixels by moving a boundary between the predicted moving range and the remaining range of the target image exclusive of the predicted moving range toward the remaining range exclusive of the predicted moving range.

8. The robot apparatus according to claim 1, wherein
the moving body detection unit generates the predicted moving range by predicting a moving direction and a moving speed of the movable unit region using the plurality of images sequentially sensed and expanding the movable unit region by pixels, the number of which is proportional to the moving speed of the movable unit region, in the predicted moving direction of the movable unit region.

9. The robot apparatus according to claim 8, wherein
the moving body detection unit expands the predicted moving range by the pixels, the number of which is proportional to the moving speed of the movable unit region, by moving a boundary between the predicted moving range and the remaining range of the target image exclusive of the predicted moving range toward the remaining range exclusive of the predicted moving range.

10. The robot apparatus according to claim 1, wherein
a plurality of the image sensing units are arranged outside the robot apparatus, and
the moving body detection unit calculates a distance in a depth direction using images obtained from the plurality of image sensing units and generates the predicted moving range on the basis of the calculated distance in the depth direction.

11. A control method for a robot apparatus having a movable unit, comprising:
a step of sensing an image of a surrounding environment by an image sensing unit;
a step of detecting, in the image, a movable unit region in which the movable unit appears;
steps of generating a predicted moving range for the movable unit region by predicting a range within which the movable unit region moves using a plurality of the images sequentially sensed and attempting to detect a moving body in the predicted moving range; and
a step of, if the moving body is detected, changing operation of the movable unit.

12. The control method for the robot apparatus according to claim 11, wherein
the step of changing the operation of the movable unit includes reducing operating speed of the movable unit if the moving body is detected.

13. The control method for the robot apparatus according to claim 11, wherein
the step of changing the operation of the movable unit includes changing a trajectory of the movable unit according to a motion of the movable unit such that the movable unit avoids the moving body if the moving body is detected.

14. The control method for the robot apparatus according to claim 11, wherein
the step of attempting to detect the moving body includes generating velocity vector distribution information within a target one of the plurality of images using the plurality of images sequentially sensed and, if a group of velocity vectors which does not include a velocity vector in the movable unit region, has magnitudes larger than a predetermined threshold value, and occupies a region larger than a predetermined size, of the velocity vector distribution information, is detected in the predicted moving range, detecting the region where the group of velocity vectors is located as the moving body.

15. The control method for the robot apparatus according to claim 14, wherein
the step of attempting to detect the moving body includes generating the second velocity vector distribution information arising from operation of the robot apparatus itself and
subtracting the second velocity distribution information from the velocity vector distribution information in advance when detecting the moving body.

16. The control method for the robot apparatus according to claim 11, wherein
the step of attempting to detect the moving body includes generating the predicted moving range by predicting a moving direction of the movable unit region using the plurality of images sequentially sensed and expanding the movable unit region in the predicted moving direction of the movable unit region by a predetermined number of pixels.

17. The control method for the robot apparatus according to claim 16, wherein
the step of attempting to detect the moving body includes expanding the predicted moving range by a predetermined number of pixels by moving a boundary between the predicted moving range and the remaining range of the target image exclusive of the predicted moving range toward the remaining range exclusive of the predicted moving range.

18. The control method for the robot apparatus according to claim 11, wherein
the step of attempting to detect the moving body includes generating the predicted moving range by predicting a moving direction and a moving speed of the movable unit region using the plurality of images sequentially sensed and expanding the movable unit region by pixels, the number of which is proportional to the moving speed of the movable unit region, in the predicted moving direction of the movable unit region.

19. The control method for the robot apparatus according to claim 18, wherein
the step of attempting to detect the moving body includes expanding the predicted moving range by a predetermined number of pixels by moving a boundary between the predicted moving range and a remaining range of the target image exclusive of the predicted moving range toward the remaining range exclusive of the predicted moving range.

20. The control method for the robot apparatus according to claim 11, wherein
the step of attempting to detect the moving body includes calculating a distance in a depth direction using images obtained from the plurality of the image sensing units arranged outside the robot apparatus and generating the predicted moving range on the basis of the calculated distance in the depth direction.
